(19) United States
(12) Patent Application Publication
(10) Pub. No.: US 2006/0268763 A1
(43) Pub. Date: Nov. 30, 2006

(54) Wireless communications device with enhanced radio capability

(75) Inventor: Mark George, Raleigh, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/137,738

(22) Filed: May 25, 2005

(51) Int. Cl. H04L 12/66; H04Q 7/00

(52) U.S. Cl. 370/328; 370/401

(57) ABSTRACT

A wireless communications device includes a receiver to receive a broadcast signal transmitted by a commercial broadcast radio station, memory, and a controller. The memory stores user-defined information that identifies multimedia content that the user is interested in recording. The broadcast signal includes multimedia content such as a song, for example, that may be rendered to the user over a speaker of the device. The broadcast signal also includes information identifying the multimedia content being transmitted. Upon receipt of the broadcast signal, the controller compares the received information identifying the multimedia content to user-defined information. If the comparison yields a match, the controller records the received multimedia content for the user. The controller may be configured to temporarily store the received multimedia content in a temporary buffer pending the results of the comparison.

### BACKGROUND

The present invention relates generally to wireless communications devices, and particularly to wireless communications devices equipped with broadcast radio receivers.

Commercial broadcast radio stations, such FM radio stations, may use a system known as a Radio Data System (RDS). RDS is a standard for sending small amounts of digital information using conventional FM radio broadcasts. RDS standardizes several types of information transmitted by the broadcast radio stations, such as the identity of the particular radio station, type of programming, and the name of an artist and/or a particular song. Suitably equipped radio receivers can receive and decode this information for display to the user. As those skilled in the art will know, RDS is used widely throughout Europe. The U.S. has an equivalent standard known as Radio Broadcast Data System (RDBS), which differs only slightly from its European counterpart. Thus, for the purposes herein, the European standard RDS and the U.S. standard RBDS are commonly referred to as “RDS.”

Commercial broadcast radio stations, such as AM/FM radio stations, transmit their programming (e.g., music) and RDS data as distinct signals multiplexed onto a single carrier. Radio receivers, such as those included with some wireless communications devices, permit a user to listen to the transmitted programming. Some wireless communications devices may even come equipped with circuitry to receive, extract, decode, and display the RDS data streams on a display for the user. While users can listen to the programming using these receivers, they typically are unable to record the programming for later enjoyment. The reasons for this are varied. One reason is that existing wireless communications devices may not be equipped to record the signals transmitted by the commercial broadcast radio stations. Even if they were, however, users have no way of knowing when a particular song may be played by a given radio station. As such, users would have to actively listen to a particular station for an indeterminate amount of time to be able to record the desired content.

### SUMMARY

The present invention provides a wireless communications device equipped with a receiver that is able to receive multimedia content such as a song, for example, transmitted by a commercial broadcast station. The wireless communications device allows a user to communicate with one or more remote parties via a wireless communications network, and may be configured to record multimedia content transmitted by the commercial broadcast station. In one embodiment, for example, the user may configure the wireless communications device to record a song transmitted by an FM radio station. The user can configure the wireless communications device to selectively record and store the multimedia content.

The wireless communications device includes memory, a receiver, and a controller. The user may define information that identifies multimedia content that the user is interested in recording. This information can be stored in memory of the user's wireless communications device, and may include, for example, the title of a song and an artist that performs the song. The receiver is operable to receive signals transmitted by broadcast stations. The transmitted signals are typically distinct signals multiplexed onto a single carrier and include both the multimedia content and information identifying the multimedia content being transmitted.

The receiver processes the multiplexed signal to render the signal carrying the multimedia content as audible sound over a speaker. A processing circuit decodes signal carrying the information, and sends the decoded information to a display for the user. The information is also sent to the controller, which compares the received multimedia identifying information to the user-defined multimedia identifying information stored in the memory of the wireless communications device. If the comparison yields a match, the controller generates a control signal to record the multimedia content. Conversely, if the comparison does not yield a match, the wireless communications device does not record the received multimedia content. Recording the received multimedia content occurs while the wireless communications device is receiving the multimedia content from the broadcast station.

The user does not need to listen to a particular broadcast station at a particular time to record a given multimedia content. In one embodiment, for example, the user may define activation and de-activation times for the receiver and store the times in memory. Responsive to these predetermined times, the controller will automatically activate and de-activate the receiver to tune to a specified frequency. While the receiver is activated, the controller will compare the received multimedia identifying information to the user-defined multimedia identifying information stored in memory. Upon detecting a match, the controller will automatically record the received multimedia content for the user. This process may continue until the controller de-activates the receiver at the specified de-activation time.

### BRIEF DESCRIPTION OF THE DRAWINGS

FIG. 1 illustrates a wireless communications device configured according to one embodiment of the present invention.

FIG. 2 illustrates a possible system in which a wireless communications device configured according to one embodiment of the present invention may operate.

FIG. 3 illustrates circuitry that may be used by one embodiment of the present invention to decode information regarding multimedia content received from a transmitting broadcast station.

FIGS. 4A and 4B illustrate some exemplary messages that may include data that identifies multimedia content transmitted by a broadcast station.

FIGS. 5A and 5B illustrate menus displayed on the wireless communications device through which a user may enter and edit configuration information according to one embodiment of the present invention.

FIG. 6 illustrates a method of recording received multimedia content according to one embodiment of the present invention.

FIG. 7 illustrates a method of recording received multimedia content according to an alternate embodiment of the present invention.

FIG. 8 illustrates a method by which a controller configured according to one embodiment of the present invention may record desired multimedia content received from a transmitting broadcast station.

### DETAILED DESCRIPTION

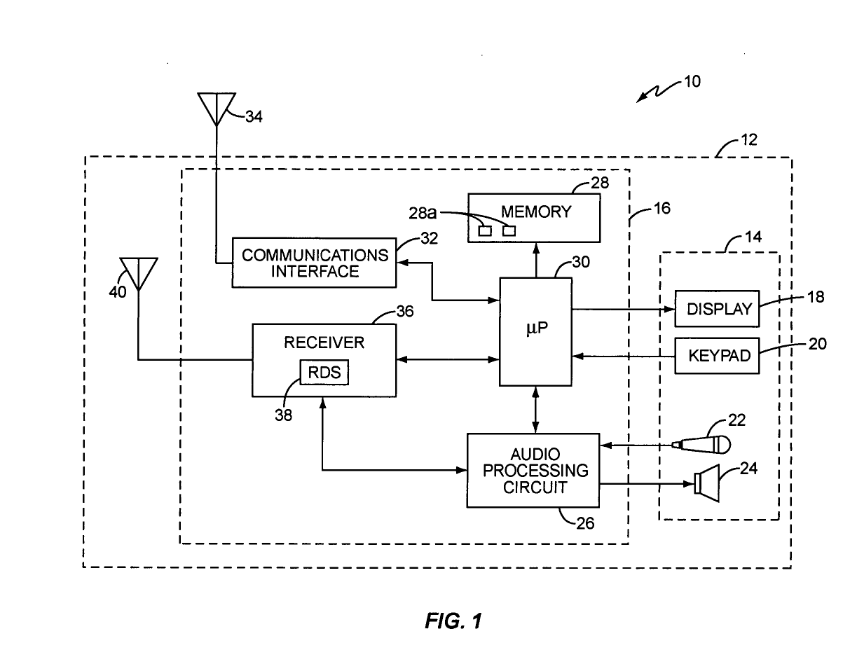

FIG. 1 illustrates a wireless communications device configured according to one embodiment of the present invention, and is generally indicated by the number 10. FIG. 1 illustrates the device in terms of a cellular telephone; however, this is merely for illustrative purposes. Those skilled in the art will readily appreciate that the present invention is applicable to any consumer electronics device capable of receiving broadcast signals. Thus, as used herein, wireless communications devices is intended to include other devices such as Personal Digital Assistants (PDAs), satellite telephones, Personal Communication Services (PCS) devices, palm computers, and the like.

As seen in FIG. 1, wireless communications device 10 comprises a housing 12, a user interface 14, and communications circuitry 16. User interface 14 provides a user with the necessary elements to interact with wireless communications device 10, and includes a display 18, a keypad 20, a microphone 22, and a speaker 24. Display 18 permits users to view dialed digits, call status, menu options, and service information typically associated with wireless communications. Display 18 also displays information that has been received from a commercial broadcast station and decoded by wireless communications device 10. This received information identifies multimedia content being transmitted by the commercial broadcast station, and may include information such as the title of a song and the artist performing the song currently being broadcast by the radio station.

Keypad 20 may be disposed on a face of wireless communications device 10, and includes an alphanumeric keypad and other input controls such as a joystick, button controls, or dials. Keypad 20 allows the operator to dial numbers, enter commands, and select options from menu systems, as well as permit the user to enter frequency information to tune to a selected broadcast station. As will be described later in more detail, the user of wireless communications device 10 can edit multimedia content that has been saved in memory 28 by entering commands through keypad 20. Microphone 22 converts the user's speech into electrical audio signals, and speaker 24 converts audio signals into audible sounds that can be heard by the user.

Communications circuitry 16 comprises a controller 30, memory 28, an audio processing circuit 26, a communications interface 32 connected to an antenna 34, and a receiver 36 having an antenna 40. Memory 28 represents the entire hierarchy of memory in wireless communications device 10, and may include both random access memory (RAM) and read-only memory (ROM). Computer program instructions and data required for operation of wireless communications device 10 are stored in non-volatile memory, such as EPROM, EEPROM, and/or flash memory, and may be implemented as discrete devices, stacked devices, or integrated with controller 30. Memory 28 may also include areas partitioned into and designated for use as temporary memory buffers 28a. Multimedia content received from a broadcast station may be temporarily stored in buffers 28a.

Controller 30 controls the operation of wireless communications device 10 according to programs stored in memory 28. The control functions may be implemented, for example, in a single microprocessor, or in multiple microprocessors. Suitable microprocessors may include general purpose and special purpose microprocessors, as well as digital signal processors. Controller 30 may interface with audio processing circuit 26, which provides basic analog output signals to speaker 24 and receives analog audio inputs from microphone 22. As described in more detail below, controller 30 may be configured to record multimedia content received from a broadcast station to memory 28 for the user responsive to user-defined criteria.

Wireless communications device 10 also comprises a communications interface 32. In FIG. 1, the communications interface 32 is embodied as a long-range transceiver coupled to antenna 34 for transmitting and receiving cellular signals to and from one or more base stations in a wireless communications network. The transceiver is a fully functional cellular radio transceiver, and operates according to any known standard, including Global System for Mobile Communications (GSM), TIA/EIA-136, cdmaOne, cdma2000, UMTS, and Wideband CDMA. The transceiver preferably includes baseband-processing circuits to process signals transmitted and received by the transceiver. Alternatively, the baseband-processing circuits may be incorporated in the controller 30.

Receiver 36 is coupled to antenna 40, and receives and demodulates signals broadcast by a radio station, such as an AM or FM radio station, for output to the user over speaker 24. Receiver 36 is suitable for use with RDS systems, and thus, may be equipped with an RDS module 38 to decode RDS information transmitted by the broadcast station. To receive the broadcast signals, receiver 36 must be tuned to the particular transmit frequency assigned to the broadcast radio station of interest. As is known in the art, receivers may use a resonance circuit to separate a radio signal of interest from the thousands of radio signals that permeate the environment. For example, receiver 36 may be tuned to a radio frequency of an FM radio station, such as 96.1 MHz, or of an AM radio station, such as 680 KHz. In these cases, receiver 36 will be tuned such that it selects only those radio signals being transmitted at 96.1 MHz or 680 KHz, respectively.

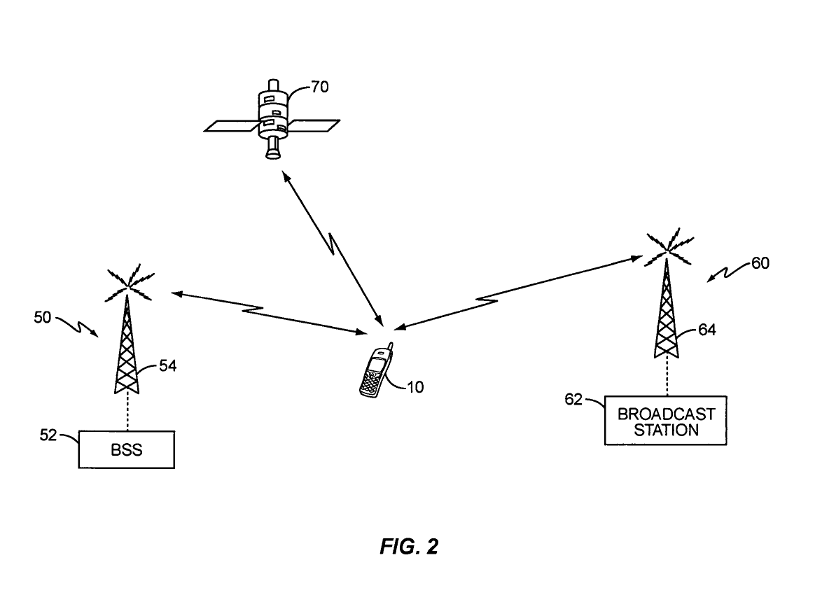

FIG. 2 illustrates a system in which wireless communications device 10 may operate. As seen in FIG. 2, wireless communications device 10 communicates with remote parties via a wireless communications network 50 that includes a base station subsystem (BSS) 52 coupled to an antenna 54. While not specifically shown in the figures, network 50 may also comprise other entities as known in the art (e.g., Location Servers, Base Station Controllers, Mobile Services Switching Centers, and the like) that facilitate communications and services provided to wireless communications device 10. Network 50 may be any private or public wireless communications network known in the art that operates according to any known standard, including Global System for Mobile Communications (GSM), TIA/EIA-136, cdmaOne, cdma2000, UMTS, and Wideband CDMA.

Wireless communications device 10 may receive broadcast radio signals from a commercial broadcast radio network 60, or alternatively, a satellite network. Network 60, for example, provides users with commercial radio programming and typically includes a broadcast radio station 62 coupled to an antenna 64. Broadcast radio station 62 may be any publicly or privately owned broadcast radio station such as an AM and/or FM radio station. The radio signals broadcast by the radio station 62 are typically modulated RF carrier signals that carry information representative of multimedia content, such as music. The radio station 62 of FIG. 2 includes equipment necessary to transmit information that identifies the multimedia content being transmitted. Suitably equipped receivers receive and decode this identifying information for display to the user. For the receiver 36 to receive the radio signals broadcast from radio station 62, receiver 36 would comprise a receiver that operates in the AM radio band (between 535 KHz and 1.7 MHz in the US) or the FM radio band (between 88 MHz and 108 MHz in the US), or both. It should be understood that the AM/FM radio bands discussed above are for illustrative purposes only, and that these radio bands may be frequencies appropriate for other regions.

A satellite network may also provide multimedia content and information identifying the multimedia content to the user. Satellite network may include one or more satellites 70 in orbit around the earth that transmits commercial radio programming, such as music and/or talk radio to users of wireless communications device 10. Companies such as SIRIUS and XM RADIO are two examples of satellite providers that provide users with commercial satellite radio programming, usually for a monthly subscription fee. In the event that wireless communications device 10 receives commercial programming via satellite signals, receiver 36 would comprise a suitable satellite receiver that operates in the GHz range.

As previously stated, receiver 36 is suitable for use with RDS systems, and thus, may be equipped with RDS module 38 in order to decode the received RDS data. RDS module 38 may be typical of any circuitry known in the art that is able to decode received RDS information. Thus, only a brief overview of the circuitry is contained herein. However, for more information on the circuitry, messaging, encoding/decoding, or on RBDS or RDS in general, the interested reader is directed to the RBDS and RDS standards entitled “United States RDBS Standard,” Apr. 9, 1998 produced by the RBDS Subcommittee of the National Radio Systems Committee (NRSC), and the European Broadcasting Union (EBU)/Cenelec Standard EN50067: 1998 “pecification of the Radio Data System,” both of which are incorporated herein by reference. It should be understood that these standards mostly describe RDS as it applies to FM broadcasts. However, these standards documents also include language indicating that the RDS system will be applied to AM broadcasts as well. Therefore, the present invention may be applied equally to AM and FM broadcasts.

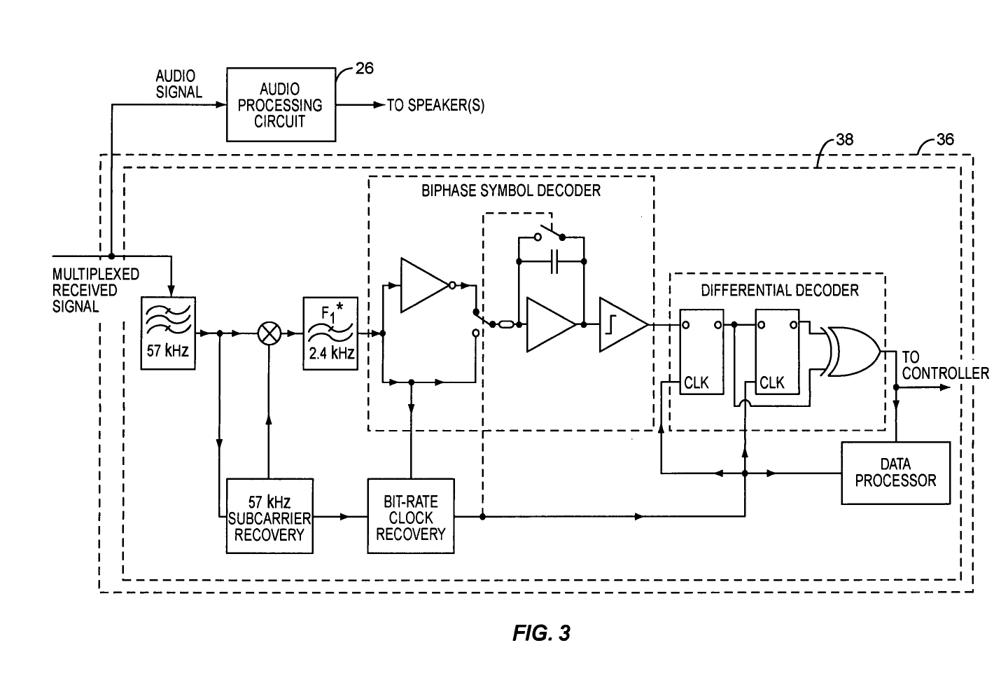

As seen in FIG. 3, the signal received from an FM broadcast radio station is sent to the audio processing circuit 26, which will render the signal as audible sound over speaker 24. The received signal is also sent to RDS module 38 for processing. RDS module 38 contains circuitry to decode a 57 kHz subcarrier signal specified by the RDS standards, and extracts any digital information carried thereon. Typically, this information is text information that identifies the title of a song and the artist performing the song, for example. Once decoded, the information may be sent by controller 30 to display 18 for display to the user. The information may also be sent to controller 30 for use in the present invention.

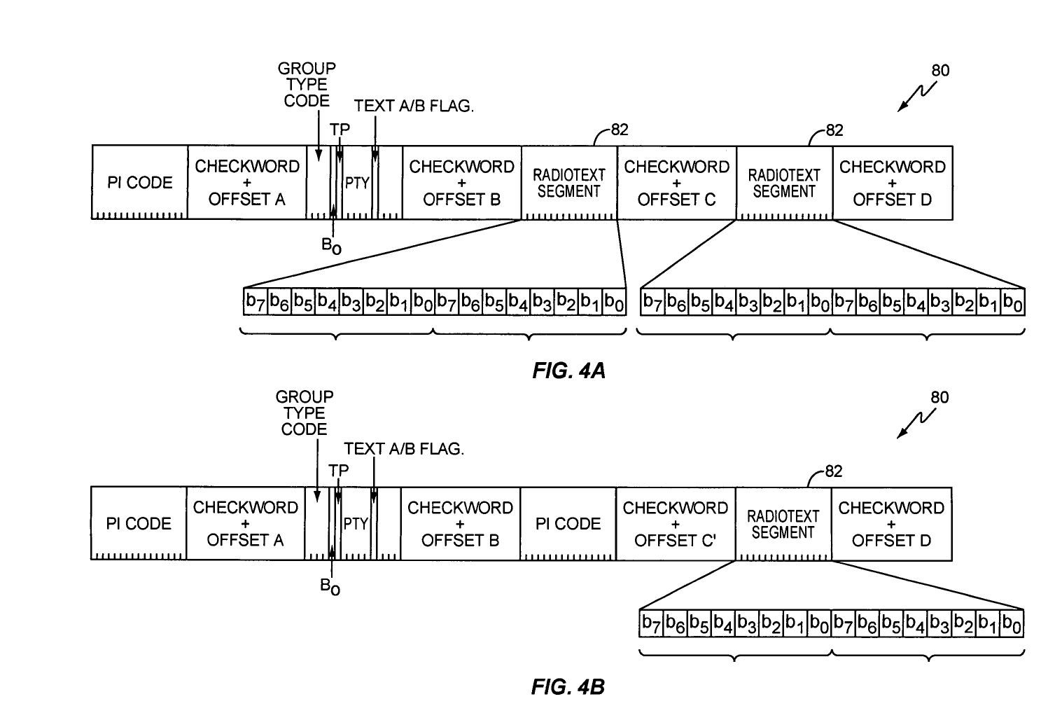

FIGS. 4A-4B illustrate two possible types of short messages that embody the RDS information as it might be transmitted by broadcast station 62. These short messages are known as RadioText (RT) messages 80. There are two types of RT messages 80—group 2A messages as seen in FIG. 4A, and group 2B messages as seen in FIG. 4B. The format differences between group 2A and 2B messages are not material to the present invention, other than the fact that they contain a different number of text segments 82.

The text segments 82 contain the bits (b₀ . . . bₙ) that carry the character data to be displayed to the user. For example, the bits b₀ . . . bₙ could include textual data that identifies the name of the song and artist. Because each character in the message is denoted using 8-bits b₀ . . . b₇, broadcast radio stations may transmit the RT messages 80 several times in succession to ensure proper reception of all characters in the message. The text segments 82 in group 2A messages comprise four characters each, and can be used to send messages of up to 64 characters in length. In contrast, the text segment 82 in group 2B messages comprise only two characters each, and can be used to send messages of up to 32 characters in length. However, RDS module 38 is configured to distinguish between the two groups by analyzing the “GROUP TYPE CODE” bits, and thus, is able to properly decode RT message 80 regardless of the group type that is transmitted.

To determine whether a new RT message 80 is being transmitted, RDS module 38 analyzes the “TEXT A/B” flag in each received RT message 80. This may occur, for example, between successive songs. For example, RDS module 38 could detect a change in the flag (e.g., from a binary “0” to a binary “1”), and generate a signal to clear display 18. The character data indicated in text segments 82 are then displayed as new text to the user. If the TEXT A/B flag remains constant, however, the character data in the text segments 82 are written to display 18. The user may view this resultant character data, for example, as a “scrolling” message across the display 18.

Conventional devices analyze the TEXT A/B flag to determine whether to clear the display 18, or to continue to “scroll” the text across display 18. According to the present invention, however, controller 30 may use the detected change in the TEXT A/B flag to distinguish between successive songs being received by receiver 36. For example, the signal generated by RDS decoder 38 when a change in the TEXT A/B flag is detected could also be used to indicate to controller 30 that a new song has been, or will be, received. Controller 30 could then use the extracted text segment data 82 to determine whether to record a song being transmitted by broadcast radio station 62.

More particularly, controller 30 may, according to one embodiment of the present invention, compare the data extracted from text segments 82 to information that has been defined by the user and stored in memory 28. This user-defined information may specify one or more particular songs the user is interested in recording. If controller 30 determines that the received information that identifies the song currently being transmitted matches a song that the user desires to record, controller 30 may generate a control signal to route the audio signal to memory 28. Conversely, if controller 30 determines that the received information does not match the user-defined information, the received song may not be recorded. This allows the user to configure wireless communications device 10 to selectively record only those songs the user is interested in recording.

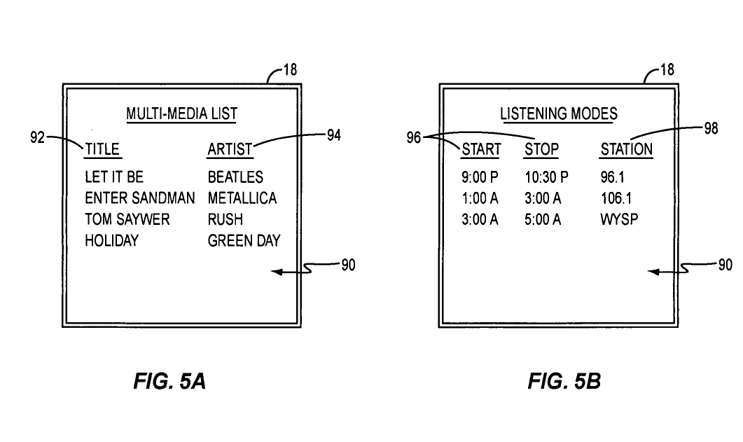

FIG. 5A, for example, illustrates one embodiment wherein the user navigates a menu 90 on wireless communications device 10 to define desired content. The menu 90 might include a title of a song 92 and an artist 94 that performs the song. Other information could be included in addition to, or in lieu of, the title 92 and artist 94. Controller 30 may be configured to record only that content specified by the user and stored in memory 28. The user might enter the information using keypad 20, for example, or download the information from a remote computing device (e.g., a laptop or a Personal Digital Assistant—PDA) via cabling, short-range wireless transmission via BLUETOOTH, or other connection media.

According to the present invention, the user is able to record multimedia content such as songs while the user is actively listening to a desired radio station. However, the user need not manually start a recording, and at times, it may be inconvenient to manually start a recording. For example, there may be times in which the user is unable to actively listen to a particular station, for example, at night when the user is sleeping. Therefore, the present invention may provide an additional menu option that enables the user to specify when receiver 36 should be active, and to what particular station receiver 36 should be tuned.

FIG. 5B, for example, illustrates such a menu option that includes a start time and an end time 96, and a desired station 98. The start and end times 96 specify when receiver 36 should be activated and de-activated, respectively. Station identifier 98, which could indicate frequency or a label associated with a specific frequency, specifies the station the user would like the receiver 36 to be tuned to while activated during the period specified by the start and end times 96. Specifying the start and end times 96 and the particular station 96 allow for the automatic recording of desired multimedia content while minimizing battery use.

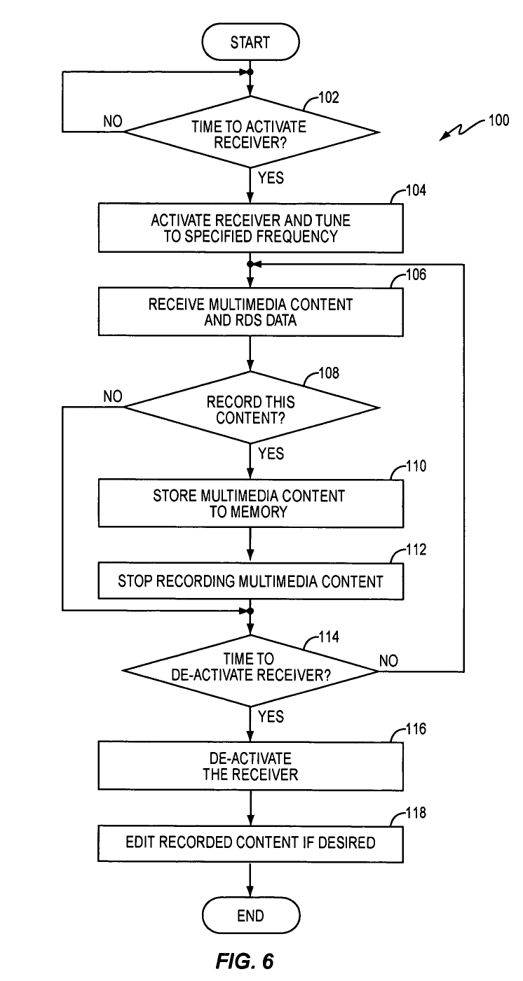

FIG. 6 illustrates a method 100 according to one embodiment of the present invention by which controller 30 operates receiver 36 to tune to a particular station at a specified time to record one or more user-specified songs. The method 100 begins when controller 30 determines that the current time matches that of a user-specified start time 96 and activates the receiver 36 (box 102). Once activated, controller 30 tunes receiver 36 to a user-specified frequency 98 (box 104), and begins to receive the multimedia content, such as a song, and the RDS stream transmitted by broadcast station 62 (box 106). The RDS stream might include, for example, the title of a song and the artist that performs the song. RDS module 38 decodes and extracts the character data from text segment 82 as previously described, and sends the data to controller 30. Receiver 36 may or may not send the audio signal to audio processing circuit 26 for rendering through speaker 24.

The RDS data identifying the song being transmitted by broadcast radio station 62 may span multiple text segments 82 and/or be transmitted in one or more RT messages 80. Therefore, controller 30 may buffer the decoded data until all the characters are received, or alternatively, until a predetermined number of characters has been received from RDS module 38. When the decoded data has been received, controller 30 may compare the decoded data that identifies the song being received with the user-specified data stored in memory (box 108). If a match occurs, controller 30 may generate a control signal that causes receiver 36 to route the received audio signal to memory 28 where it is saved for the user (box 110). When the song is over, controller 30 may generate a second control signal to cease recording (box 112). Controller 30 may then determine whether the current time matches the user-specified end-time (box 114), and de-activate the receiver 36 accordingly (box 116). As described later in more detail, the user may also edit the recorded content (box 118) as desired.

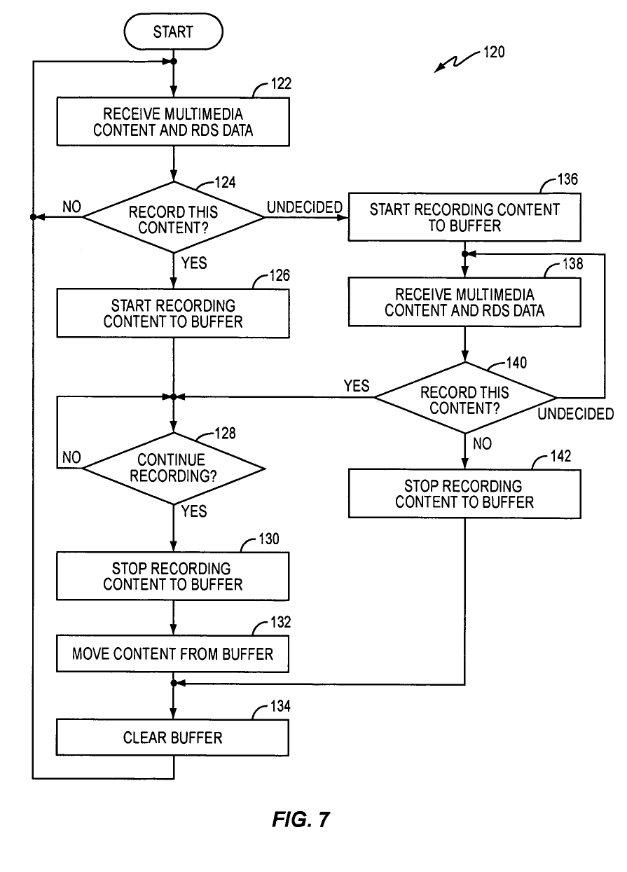

It should be noted that, in practical terms, the receipt and decoding of the RDS data stream and the multimedia content it identifies might not always be synchronized. For example, a user might hear the beginning of a song being received before the RDS data stream is completely decoded, or before controller 30 has definitively determined whether the song should be recorded. Thus, wireless communications device 10 might undesirably delay the start of a recording, which might mean that only a portion of the song is recorded. Thus, controller 30 may be configured to temporarily “buffer” a received audio stream. Method 120 of FIG. 7, for example, illustrates such an embodiment where controller 30 utilizes the one or more buffer areas 28a of memory 28 to ensure that an entire song is recorded. For this embodiment, it is assumed that receiver 36 has been activated either manually by the user, or automatically as described previously.

Method 120 begins when receiver 36 receives the transmitted song and associated RDS data stream identifying the song (box 122). Controller 30 than begins comparing the decoded data identifying the song being received and the user-defined data identifying the content the user wishes to record (box 124). This portion of the method may continue (box 152,154) until controller 30 determines that a match has occurred, or is possible. When a match occurs (box 124), controller 30 generates a control signal to start recording the received audio to a buffer 28a (box 126). Recording to the buffer may continue until the song ends (box 128). When the song ends, controller 30 generates a second control signal to stop the recording of the song being received (box 130). As previously described, controller 30 may generate these control signals based on analyzing the TEXT A/B flag received with the RDS data stream. Once the recording has been stopped, controller 30 may move the recorded song from temporary buffer 28a to another area of memory 28 (box 132) and clears the buffer for the next recording attempt (box 134).

In some cases, controller 30 may not have received enough decoded information to make a decision regarding whether the user wishes to record the particular song being received. Alternatively, the receipt of the decoded data could have been significantly delayed. Thus, controller 30 could start recording the song being received (box 136) and make one or more subsequent comparisons (box 140) as the decoded data is received (box 138). The subsequent comparisons may continue as long as controller 30 is unable to definitively determine whether a match or a no-match condition has occurred (box 140). When a match occurs during the subsequent comparisons (box 140), recording is continued (box 128) until a change in the TEXT A/B flag, for example, is detected. When a no-match condition occurs during the subsequent comparisons (box 140), controller 30 stops the recording (box 142) and clears the buffer (box 134). Since, in this case, the user did not indicate the song temporarily stored in buffer 28a as a song to be recorded, it would not be moved to another area of memory 28.

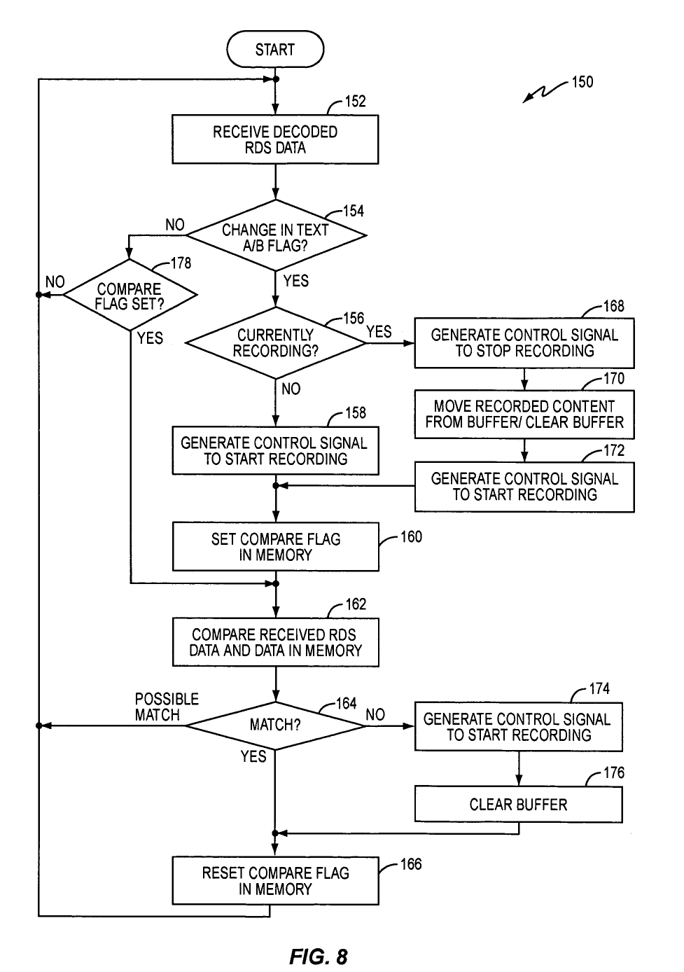

FIG. 8 illustrates how controller 30 might be configured according to one embodiment of the present invention. Method 150 begins when receiver 36 receives the song and the RDS data stream being transmitted by broadcast station 62 (box 152). Controller 30 checks the decoded data to determine whether there has been a change in the TEXT A/B flag (box 154). A change in the TEXT A/B flag could indicate that a new song is being received or will be received. If a new song is being received, controller 30 may check to see if the previous song is being recorded (box 156). If not, controller 30 generates a control signal to start a recording to buffer 28a (box 158) and sets a “compare flag” in memory 28 (box 160), which is described later in more detail. Controller 30 than compares the decoded data to the user-defined data to determine a match/no-match condition (box 164). A match condition (box 164) may cause controller 30 to reset the compare flag (box 166). A no-match condition causes controller 30 to stop the recording (box 174), clear the buffer 28a (box 176), and reset the compare flag. A possible match (box 164) may result in additional comparisons made by controller 30 as subsequent RDS data is received and decoded (box 152). If the previous song is being recorded (box 156) when the new song is received (box 156), controller 30 may generate a control signal to stop the current recording (box 168), and may move the recorded song from buffer 28a (box 170). Controller 30 may then generate a control signal to begin recording the newly received song (box 172).

As previously stated, controller 30 may set and reset a “compare flag.” The compare flag may be set based on the comparison results, and may be used to indicate to controller 30 whether it should continue to compare the decoded data of subsequently received RDS streams to the data stored in memory 28 (box 162). In one embodiment, for example, the compare flag is a TRUE/FALSE indicator that might be set to TRUE (box 160) to indicate that controller 30 should compare the received multimedia identifying data and the user-defined data in memory. This might occur whenever a new song arrives, or whenever controller 30 has not definitively determined a result of a comparison (e.g., additional data from subsequent RDS data streams is needed to determine a match/no-match condition). Alternatively, the compare flag might be set to FALSE (box 166) whenever controller 30 definitively determines that either a match or a no-match condition exists. Thus, checking the value of the compare flag (box 178) might prevent unnecessary comparisons of the data if controller 30 has already definitively determined that a song being received should or should not be recorded.

Once a song has been successfully recorded to memory 28, controller 30 may automatically remove the song from the user-defined list. Alternatively, controller 30 may mark the song as recorded for later manual removal by the user. This might allow the user to determine when a particular song has been recorded, and may prevent controller 30 from recording the same song more than once. Once the song is recorded, the user may playback the song in memory and “edit” the song using keypad 20. This may be useful, for example, in cases where the recorded song or multimedia content includes undesirable “overlapping” audio such as a commercial or a disk jockey talking at the beginning or end of the song. For example, the user may use the keypad 20 to delete some of the beginning and/or end of the song to delete the undesirable audio. The undeleted portion of the song may than be re-written to memory 28 so that the user can listen to or download the song from memory 28 as desired.

Those skilled in the art will appreciate that the present invention is not limited to RDS information transmitted by suitably equipped FM radio stations. Rather, the present invention may also be practiced where the RDS information comes from a satellite or AM radio station. In cases where a satellite transmits both the audio and the RDS data, wireless communications device 10 may be a dual-mode satellite phone. Moreover, the multimedia content received by receiver 36 is not limited strictly to audio, but instead, may also be video or images or other multimedia content.

Additionally, the present invention is not limited solely to the AM and FM frequency bands explicitly stated above. Rather, various geographical regions and/or technologies may define and support commercial radio transmissions at frequencies other than those described above. Thus, the present invention may also operate to receive broadcast signals within any radio frequency range.

Further, the present invention has been described in terms of controller 30 receiving the decoded data, and making the necessary comparisons. However, this is for illustrative purposes only. In alternate embodiments, RDS module 38 makes the comparisons and indicates the results to controller 30 and/or generates the control signals to start/stop the recording, and/or tune receiver 36. In other embodiments, controller 30 may be integrated with RDS module 38 or receiver 36. In still other embodiments, receiver 36 passes the received RDS data stream to controller 30. In these cases, controller 30 may or may not be integrated with RDS module 38.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communications device comprising:
memory operative to store user-defined information identifying multimedia content that a user wishes to record;
a receiver operative to receive a broadcast signal that includes multimedia content and information identifying the received multimedia content; and
a controller operatively connected to the receiver, and configured to generate a control signal to record the received multimedia content to the memory based on a comparison between the received multimedia identifying information and the user-defined multimedia identifying information.

2. The device of claim 1 further comprising a transceiver operative to transmit signals to and receive signals from a remote party via a wireless communications network.

3. The device of claim 1 wherein the controller is further operative to activate and de-activate the receiver automatically based on user-defined times stored in the memory.

4. The device of claim 1 wherein the controller is further operative to activate and de-activate the receiver responsive to user input.

5. The device of claim 1 wherein the controller is further configured to store the received multimedia content in the memory if the received multimedia identifying information matches the user-defined multimedia identifying information.

6. The device of claim 5 further comprising a speaker, and wherein the controller is further configured to playback the received multimedia content stored in memory to the user.

7. The device of claim 5 wherein the controller is further configured to edit the received multimedia content stored in memory responsive to user input, and save the edited multimedia content in the memory.

8. The device of claim 1 wherein the controller is further configured to temporarily store the received multimedia content in a buffer pending the results of the comparison.

9. The device of claim 8 wherein the controller is further configured to move the received multimedia content from the buffer to non-buffer memory if the received multimedia identifying information matches the user-defined multimedia identifying information.

10. The device of claim 8 wherein the controller is further configured to stop storing the received multimedia content to the buffer if the received multimedia identifying information does not match the user-defined multimedia identifying information.

11. The device of claim 1 wherein the controller is further configured to start recording the received multimedia content responsive to detecting a first indicator included in the received multimedia identifying information, and to stop recording the received multimedia content responsive to detecting a second indicator included in the received multimedia identifying information.

12. The device of claim 11 wherein the first and second indicators comprise flags that mark the beginning and the end of the received multimedia content, respectively.

13. The device of claim 1 wherein the received multimedia content comprises a song, and the received multimedia identifying information includes the title of the song and the artist associated with the song.

14. The device of claim 1 wherein the broadcast signal is received from a satellite.

15. The device of claim 1 wherein the broadcast signal is received from a commercial broadcast radio station.

16. The device of claim 1 further comprising a processing circuit to decode the received multimedia identifying information, and to send the decoded information to a display of the device.

17. The device of claim 1 wherein the controller is further configured to record the multimedia content while the receiver is receiving the multimedia content.

18. A method of storing multimedia content in memory of a wireless communications device, the method comprising:
storing, in a memory of the wireless communications device, user-defined information that identifies multimedia content that a user wishes to record;
receiving a broadcast signal at the wireless communications device, the broadcast signal comprising multimedia content and information identifying the received multimedia content; and
recording the received multimedia content to the memory based on a comparison between the received multimedia identifying information and the user-defined multimedia identifying information.

19. The method of claim 18 wherein recording the received multimedia content comprises recording the received multimedia content to the memory while the multimedia content is being received.

20. The method of claim 18 wherein recording the received multimedia content comprises temporarily storing the received multimedia.

21. The method of claim 20 further comprising moving the temporarily stored multimedia content to the memory if the received multimedia identifying information matches the user-defined multimedia identifying information.

22. The method of claim 20 further comprising ceasing to record the received multimedia content if the received multimedia identifying information does not match the user-defined multimedia identifying information.

23. The method of claim 19 further comprising starting to record the received multimedia content responsive to a first indication received with the multimedia identifying information.

24. The method of claim 23 further comprising ceasing to record the received multimedia content responsive to a second indication received with the multimedia identifying information.

25. The method of claim 18 further comprising automatically activating a receiver to receive the broadcast signal during a predetermined time period specified by a user.

26. The method of claim 18 further comprising activating a receiver to receive the broadcast signal responsive to user input.

27. The method of claim 19 further comprising storing the received multimedia content in the memory if the received multimedia identifying information matches the user-defined multimedia identifying information.

28. The method of claim 27 further comprising editing the stored multimedia content responsive to user input, and saving the edited multimedia content.

29. The method of claim 18 wherein the received multimedia content comprises a song, and the received multimedia identifying information includes a title of the song and an artist associated with the song. 30. The method of claim 18 further comprising transmitting signals to and receiving signals from a remote party via a wireless communications network.
